(19) United States
(12) Patent Application Publication
(10) Pub. No.: US 2009/0222841 A1
(43) Pub. Date: Sep. 3, 2009

(54) ACCELERATION OF RECEIVE DATA THROUGHPUT OF A USB DEVICE

(75) Inventors: Abhijit Shashikant Mirajkar, Hyderabad (IN); Milton Joseph Fernandes, Hyderabad (IN)

Correspondence Address: LOWE HAUPTMAN HAM & BERNER, LLP, 1700 DIAGONAL ROAD, SUITE 300, ALEXANDRIA, VA, 22314, US

(73) Assignee: MOSCHIP SEMICONDUCTOR TECHNOLOGY LIMITED, Hyderabad (IN)

(21) Appl. No.: 12/041,240

(22) Filed: Mar. 3, 2008

(51) Int. Cl. G06F 9/44; G06F 3/00

(52) U.S. Cl. 719/321; 710/52

(57) ABSTRACT

This invention proposes a procedure by which one or more number of IRPs (IO Request Packets) can be always kept pending with the USB Host controller in order to get the incoming data as soon as it arrives. When data arrives the USB Host Controller and driver will complete the IRP Request and the USB Client driver will buffer this data if there is no READ request pending from the application layer; else it will complete the application requests with data received from the device.

### BACKGROUND

1. Technical Field

The embodiments herein generally relate to data transfer from USB devices, and, more particularly, to acceleration of receive data throughput of a USB device.

2. Description of the Related Art

The data transfer mechanism in USB is implemented by having a Host Controller polling the devices for data on Bulk_in endpoint. The Host Controller issues these requests based on instructions from a client driver. Hence a polling mechanism has to be used to receive data from a device and this introduces latencies. The data received by the hardware lies with the hardware until the data is read by the client driver on behalf of a user mode application when the application issues a request. Patent U.S. Pat. No. 6,412,028 talks about a virtual Direct Memory Access (DMA) software which emulates the operations of a DMA device. The virtual DMA intercepts DMA instructions provided by a Data Acquisition (DAQ) driver level software to acquire data from the device and the virtual DMA requests data in bulk packets from the device. Then it stores these packets in the computer's memory thus reducing recursive access and acquisition time of the system. However, the data is read from the external device into the memory only after an application makes a request for the data.

Hence there is a need to reduce the time for which the received data stays with the system.

### SUMMARY

In view of the foregoing, an embodiment herein provides a method to reduce time for which data stays with hardware in a USB subsystem in a windows operating system environment, the method comprising the steps of a USB client driver creating IO Request Packets (IRPs) to receive data from device through a USB host controller; the USB client driver submitting IRPs to the USB subsystem to read any incoming data from the USB device; having at least one IRP pending to receive any incoming data from the device; copying data into a container buffer, when an IRP is completed; and re-submitting IRP back to USB subsystem.

Another embodiment provides a method to receive data from a device through USB in a Bulk mode and reduce time for which data stays with hardware in a windows operating system environment, the method comprising the steps of a USB client driver creating a pool of IRPs to be used for reading incoming data from a USB host controller; creating a non-paged buffer per device to receive data, where the non-paged buffer serves as container buffer for incoming data from said device; the USB client driver creating IRPs to receive data from device through a USB host controller; the USB client driver submitting created IRPs to the USB host controller to read any incoming data from a USB device; having at least one IRP pending to receive any incoming data from the USB device; copying data into a container buffer, when an IRP is completed; and re-submitting the IRP back to USB subsystem.

An embodiment further provides a computer readable medium comprising instructions to perform a method to receive data from a device through USB in a Bulk mode and reduce time for which data stays with hardware in a windows operating system environment, the computer readable medium comprising instructions to perform the steps of s USB client driver creating a pool of IRPs to be used for reading incoming data from a USB host controller; creating a non-paged buffer per device to receive data, where the non-paged buffer serves as container buffer for incoming data from the USB device; the USB client driver creating IRPs to receive data from device through a USB host controller; the USB client driver submitting created IRPs to the USB host controller to read any incoming data from the USB device; having at least one IRP pending to receive any incoming data from the USB device; copying data into a container buffer, when an IRP is completed; and re-submitting IRP back to USB subsystem.

An embodiment further provides a computer to perform a method to receive data from a device through USB in a Bulk mode and reduce time for which data stays with hardware in a windows operating system environment, the computer comprising of a USB host controller to control client drivers; at least one USB client driver means to create a pool of IRPs to be used for reading incoming data from at least one device, where said data from said at least one device is read through the host controller, and where the client driver is adapted to keep at least one IRP pending with the host controller to receive data coming from said at least one device; and a container non-paged buffer per at least one device, to contain incoming data from at least one device.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF THE DRAWINGS

The embodiments herein will be better understood from the following detailed description with reference to the drawings, in which:

FIG. 1 illustrates schematic diagram of USB device stack according to various embodiments as described herein;

FIG. 2 illustrates communication between a USB client driver and a USB Host controller according to various embodiments as described herein;

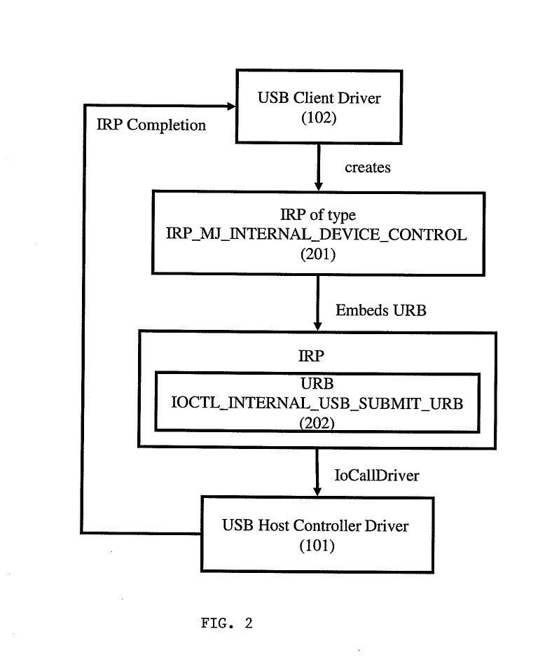

FIG. 3 illustrates the client driver buffer structure according to various embodiments as described herein;

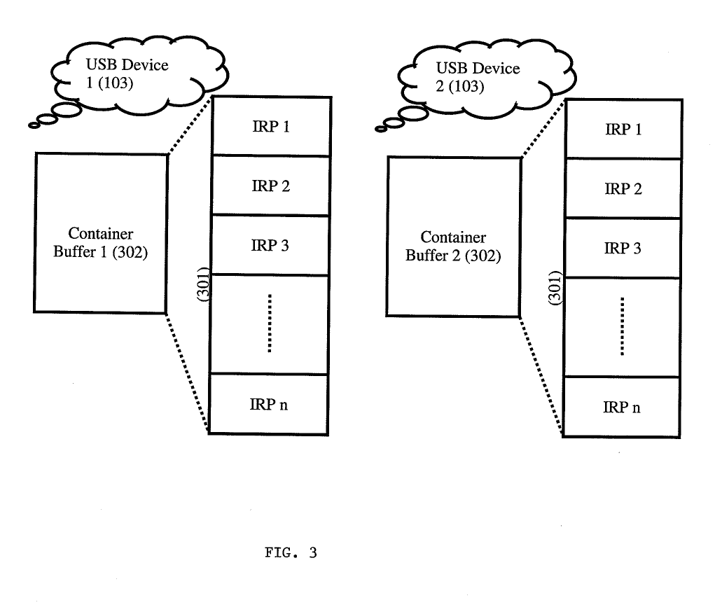

FIG. 4 is a flow diagram illustrating a preferred method according to various embodiments as described herein;

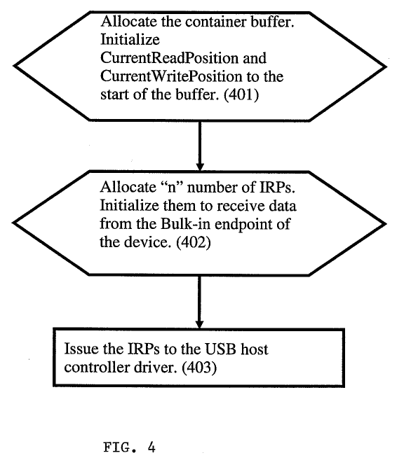

FIG. 5 is a flow diagram illustrating a preferred method according to various embodiments as described herein; and

FIG. 6 is a flow diagram illustrating a preferred method according to various embodiments as described herein.

### DETAILED DESCRIPTION OF PREFERRED EMBODIMENTS

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

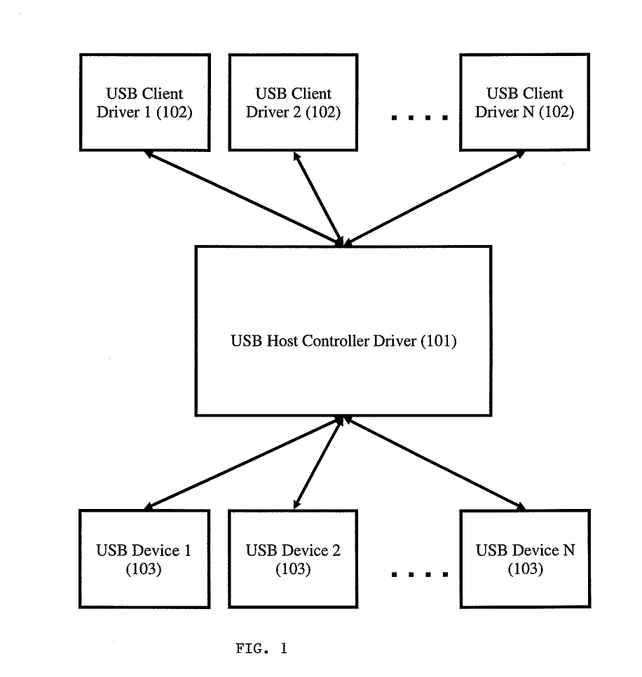

A host controller (101) provides the interface between a USB device (103) and its driver. The host controller (101) controls all access to USB resources. The driver of a USB device (client driver) (102) uses the services provided by said USB host controller driver (101) to communicate with said USB device (103) it controls. FIG. 1 shows USB device stack (103) in the Windows Operating system, USB Client drivers (102) are provided by the vendor, USB Host Controller driver (101) is provided by Microsoft.

The communication interface between USB client drivers (102) and USB Host Controller driver (101) is through I/O Control (IOCTL) requests sent in the form of I/O request packet (IRP) of type IRP_MJ_INTERNAL_DEVICE_CONTROL. This is a standard defined interface by Microsoft that USB Client drivers (102) need to follow. The USB client driver (102) creates an IRP of type IRP_MJ_INTERNAL_DEVICE_CONTROL (201). This IOCTL request contains IOCTL_INTERNAL_USB_SUBMIT_URB (202), which is a defined device control code for USB Client Drivers. To send data to and receive data from the device, said USB Client driver (102) creates IRPs and sends said IRPs to Host Controller driver (101) that in turn sends them to said USB device (103). Upon receiving the data on a given endpoint, host controller driver (101) copies received data into the buffers given by IRP and gives IRP back to the client driver. An IRP consists of a USB Request Block (URB), the structure of a URB is as shown below.

```
typedef struct _URB {
union {
struct _URB_HEADER UrbHeader;
struct _URB_SELECT_INTERFACE UrbSelectInterface;
struct _URB_SELECT_CONFIGURATION UrbSelectConfiguration;
struct _URB_PIPE_REQUEST UrbPipeRequest;
struct _URB_FRAME_LENGTH_CONTROL UrbFrameLengthControl;
struct _URB_GET_FRAME_LENGTH UrbGetFrameLength;
struct _URB_SET_FRAME_LENGTH UrbSetFrameLength;
struct _URB_GET_CURRENT_FRAME_NUMBER UrbGetCurrentFrameNumber;
struct _URB_CONTROL_TRANSFER UrbControlTransfer;
struct _URB_BULK_OR_INTERRUPT_TRANSFER UrbBulkOrInterruptTransfer;
struct _URB_ISOCH_TRANSFER UrbIsochronousTransfer;
struct _URB_CONTROL_DESCRIPTOR_REQUEST UrbControlDescriptorRequest;
struct _URB_CONTROL_GET_STATUS_REQUEST UrbControlGetStatusRequest;
struct _URB_CONTROL_FEATURE_REQUEST UrbControlFeatureRequest;
struct _URB_CONTROL_VENDOR_OR_CLASS_REQUEST
  UrbControlVendorClassRequest;
struct _URB_CONTROL_GET_INTERFACE_REQUEST
  UrbControlGetInterfaceRequest;
struct _URB_CONTROL_GET_CONFIGURATION_REQUEST
  UrbControlGetConfigurationRequest;}
} URB, *PURB;
```

To read the data from a Bulk-In endpoint, a client driver (102) sets up an IRP with the structure, _URB_BULK_OR_INTERRUPT_TRANSFER, and passes it to said driver of USB Host Controller (101). Upon receiving the data on the given endpoint, said driver of the host controller (101) copies the received data into the buffers given by the IRP and gives the IRP back to said client driver (102).

To reduce the time for which the data stays with the hardware, USB client driver (102) creates a pool of IRPs (301) which will be used for reading incoming data from said host controller (101). USB client driver (102) will also have a non-paged buffer (302) created per device which serves as the container for the incoming data from a USB device (103). This container buffer (302) will be circular, i.e. when the end of buffer is reached, the received data will be copied from the start of the buffer area, if sufficient space is available.

To determine where to copy the received data and from where to feed the received data to the application two reference pointers, CurrentWritePosition and CurrentReadPosition respectively, will be used. The size of said container buffer (302) is allocated and CurrentWritePosition and CurrentReadPosition pointers are initialized to the start of said container buffer (302) (401). A number of IRPs are allocated and these IRPs are initialized to receive data from the bulk-in endpoint of said USB device (103) (402). Number of IRPs used, which is a configurable parameter, will be decided such that there will always be at least one IRP pending to receive any incoming data from USB device. Said IRPs are then issued to said USB host controller driver (101) (403) to read any incoming data from USB device.

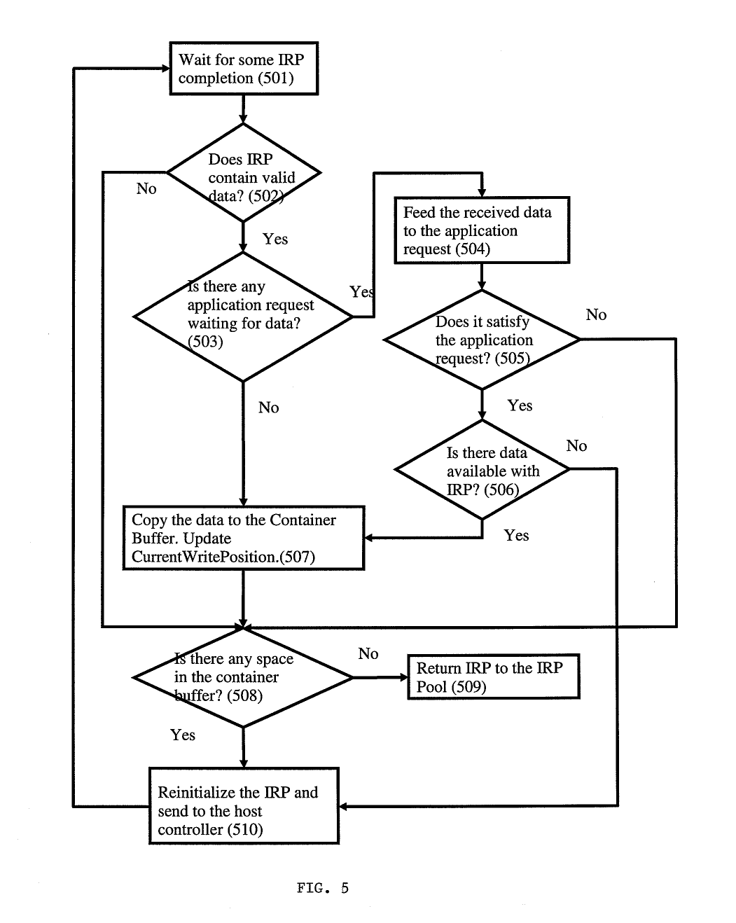

Once an IRP is completed, the data in the IRP is copied into said container buffer (302) at the location given by CurrentWritePosition and said IRP will be re-submitted back to USB subsystem. Considering FIG. 5, once an IRP is completed (501), a check is carried out to see if said IRP contains valid data (502). If said IRP does not contain any valid data, it is checked if said container buffer has any space available (508). If said container buffer has no space available, said IRP is returned to IRP pool (301) (509). If said container buffer has space available, said IRP is initialized and is sent to said host controller (101) (510). If said IRP contains valid data, a further check is carried out to see if there is any application request waiting for data (503). If there is no application request waiting for data, the data in said IRP is copied to said container buffer (302) and CurrentWritePosition is updated (507). If there is any application request waiting for data, then the received data in said IRP is fed to said application request (504). It is then checked if said application request has been satisfied (505). If said application request has been satisfied, then it is checked if said IRP contains more data (506). If said IRP contains more data, the data in said IRP is copied to said container buffer (302) and CurrentWritePosition is updated (507). If there is no data available with said IRP, said IRP is reinitialized and sent to said host controller (101) (510). If the application request is not satisfied, then it is checked if said container buffer has any space available (508). If said container buffer (302) has no space available, said IRP is returned to the IRP pool (509). If said container buffer (302) has space available, said IRP is initialized and is sent to said host controller (101) (510). Once the data in said IRP is copied to said container buffer (302) and CurrentWritePosition is updated (507), it is checked if said container buffer has any space available (508). If said container buffer has no space available, said IRP is returned to IRP pool (301) (509). If said container buffer has space available, said IRP is initialized and is sent to said host controller (101) (510). Once IRP has been sent to said host controller (101) (510), the wait for an IRP to complete starts again (501).

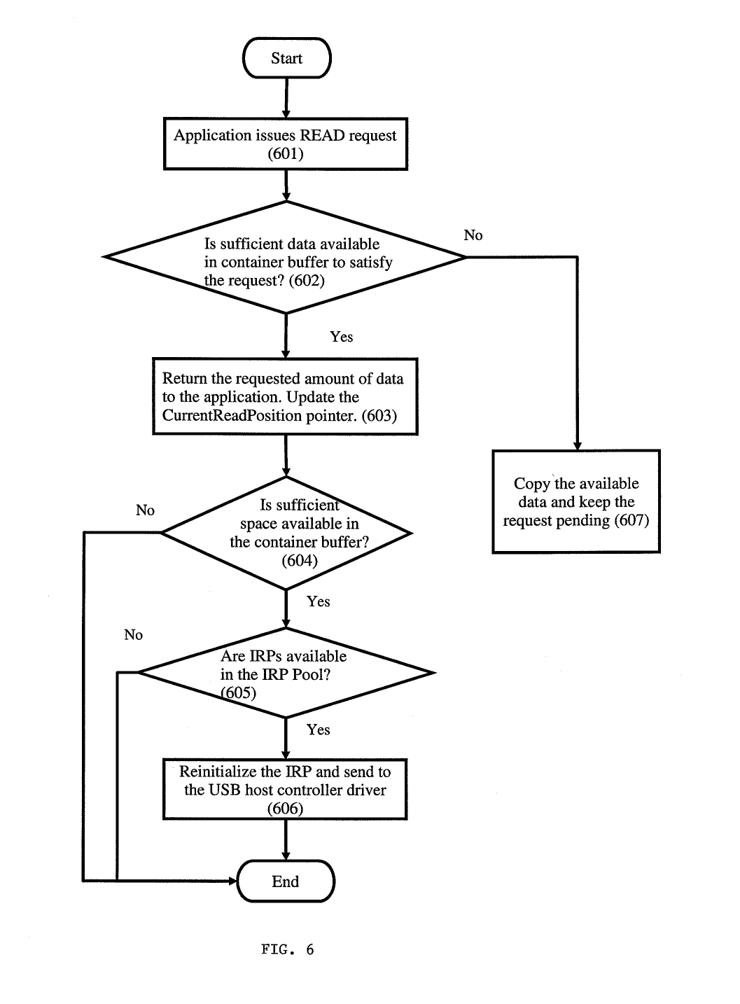

When an application requests for any data, the data already read in the container buffer will be made available to it using CurrentReadPosition, thereby reducing the application's waiting time considerably. If the container buffer gets full because of application not reading any data, the further scheduling of completed IRPs again to the USB subsystem will be held back until there is some space available in the container buffer to hold any read data. Considering FIG. 6, once an application issues a READ request (601), it is checked if sufficient data is available in said container buffer (302) to satisfy the request (602). If sufficient data is not available in said container buffer (302) to satisfy the request, the available data is copied and request is kept pending (607). The request subsequently gets completed when some data becomes available in the container buffer (503). If sufficient data is available in said container buffer (302) to satisfy the request, the requested amount of data is returned to application and the CurrentReadPosition pointer is updated (603). It is then checked if there is sufficient space available in said container buffer (302) to hold more data (604). If there is no sufficient space in said container buffer (302) to hold more data, the process is terminated. The space in the container buffer will only be available when application issues a READ next time, at which time said container buffer will be checked again for available free space. If there is sufficient space in said container buffer (302) to hold more data, it is further checked if any IRPs are available in said IRP pool (301). If there are no IRPs available in said IRP pool (301), the process is terminated. An IRP will be available only when a previously pending IRP is completed and then said RIP will be submitted again if space is available in said container buffer (302) at that time (508). Ideally, this condition never occurs and number of IRPs should be increased so as to have at least one IRP pending at any given time. If there are IRPs available in said IRP pool (301), an IRP is initialized and is sent to said USB host controller driver (101).

The subject disclosed above eliminates the delay caused by USB subsystem on the Windows platform by keeping one or more IRPs pending with the host controller driver so that data is received from the device as soon as it has received the data. Hence overall application throughput will have improved if the USB Client driver implements the mentioned embodiment on the receive data path. This embodiment is best suited for real time applications that demand low latency with high bandwidth utilization.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the spirit and scope of the appended claims.

What is claimed is:

1. A method to reduce time for which data stays with hardware in a USB subsystem in a windows operating system environment, the method comprising the steps of:
a) a USB client driver creating IO Request Packets (IRPs) to receive data from device through a USB host controller;
b) said USB client driver submitting IRPs to said USB subsystem to read any incoming data from a device;
c) having at least one IRP pending to receive any incoming data from the device;
d) copying data into a container buffer, when an IRP is completed; and
e) re-submitting IRP back to USB subsystem.

2. The method of claim 1, where a pool of IRPs are created.

3. The method of claim 1, where the number of IRPs created is configurable.

4. The method of claim 1, where said container buffer is a non-paged buffer per device.

5. The method of claim 1, the method further comprising the step of having two reference pointers, CurrentWritePosition to determine where to copy received data and CurrentReadPosition to determine to read data to feed the received data to a requesting application.

6. The method of claim 1, the method further comprising the step of copying IRP data into said container buffer at location given by said CurrentWritePosition

7. The method of claim 1, the method further comprising the step of reading data from said container buffer at location given by said CurrentReadPosition, when an application requests data.

8. The method of claim 1, the method further comprising the step of copying received data from the start of said container buffer, when the end of said container buffer is reached if sufficient space is available.

9. The method of claim 1, the method further comprising the step of holding back further scheduling of completing IRPs again to the USB subsystem until there is space available in said container buffer to hold any read data, when said container buffer is full.

10. A method to receive data from a device through USB in a Bulk mode and reduce time for which data stays with hardware in a windows operating system environment, the method comprising the steps of:
a) a USB client driver creating a pool of IRPs to be used for reading incoming data from a USB host controller;
b) creating a non-paged buffer per device to receive data, where said non-paged buffer serves as container buffer for incoming data from said device;
c) said USB client driver creating IRPs to receive data from device through a USB host controller;
d) said USB client driver submitting created IRPs to said USB host controller to read any incoming data from a device;
e) having at least one IRP pending to receive any incoming data from said device;
f) copying data into a container buffer, when an IRP is completed; and
g) re-submitting IRP back to USB subsystem.

11. The method of claim 8, where the number of IRPs created is configurable.

12. The method of claim 8, the method further comprising the step of having two reference pointers, CurrentWritePosition to determine where to copy received data and CurrentReadPosition to determine to read data to feed the received data to a requesting application.

13. The method of claim 8, the method further comprising the step of copying IRP data into said container buffer at location given by said CurrentWritePosition

14. The method of claim 8, the method further comprising the step of reading data from said container buffer at location given by said CurrentReadPosition, when an application requests data.

15. The method of claim 8, the method further comprising the step of copying received data from the start of said container buffer, when the end of said container buffer is reached if sufficient space is available.

16. The method of claim 8, the method further comprising the step of holding back further scheduling of completing IRPs again to the USB subsystem until there is space available in said container buffer to hold any read data, when said container buffer is full.

17. A computer readable medium comprising instructions to perform a method to receive data from a device through USB in a Bulk mode and reduce time for which data stays with hardware in a windows operating system environment, the computer readable medium comprising instructions to perform the steps of:
a) a USB client driver creating a pool of IRPs to be used for reading incoming data from a USB host controller;
b) creating a non-paged buffer per device to receive data, where said non-paged buffer serves as container buffer for incoming data from said device;
c) said USB client driver creating IRPs to receive data from device through a USB host controller;
d) said USB client driver submitting created IRPs to said USB host controller to read any incoming data from a device;
e) having at least one IRP pending to receive any incoming data from said device;
f) copying data into a container buffer, when an IRP is completed; and
g) re-submitting IRP back to USB subsystem.

18. The computer readable medium of claim 15, where the number of IRPs created is configurable.

19. The computer readable medium of claim 15, the computer readable medium further comprising instructions to perform the step of having two reference pointers, CurrentWritePosition to determine where to copy received data and CurrentReadPosition to determine to read data to feed the received data to a requesting application.

20. The computer readable medium of claim 15, the computer readable medium further comprising instructions to perform the step of copying IRP data into said container buffer at location given by said CurrentWritePosition.

21. The computer readable medium of claim 15, the computer readable medium further comprising instructions to perform the step of reading data from said container buffer at location given by said CurrentReadPosition, when an application requests data.

22. The computer readable medium of claim 15, the computer readable medium further comprising instructions to perform the step of copying received data from the start of said container buffer, when the end of said container buffer is reached if sufficient space is available.

23. The computer readable medium of claim 15, the computer readable medium further comprising instructions to perform the step of holding back further scheduling of completing IRPs again to the USB subsystem until there is space available in said container buffer to hold any read data, when said container buffer is full.

24. A computer to perform a method to receive data from a device through USB in a Bulk mode and reduce time for which data stays with hardware in a windows operating system environment, the computer comprising of:
a) a USB host controller to control client drivers;
b) at least one USB client driver means to create a pool of IRPs to be used for reading incoming data from at least one device, where said data from said at least one device is read through said host controller, and where said client driver is adapted to keep at least one IRP pending with said host controller to receive data coming from said at least one device; and
c) a container non-paged buffer per said at least one device, to contain incoming data from said at least one device.

25. The computer of claim 22, where said client driver is adapted to configure number of IRPs to be used.

26. The computer of claim 22, where the client driver comprises two reference pointers, CurrentWritePosition to copy received data and CurrentReadPosition to feed buffered data.

27. The computer of claim 22, where said container buffer is circular.
